(19) United States
(12) Patent Application Publication
(10) Pub. No.: US 2025/0125479 A1
(43) Pub. Date: Apr. 17, 2025

(54) BATTERY CELL ARRANGEMENT WITH A GAS GUIDING DEVICE AND VEHICLE

(71) Applicant: AUDI AG, Ingolstadt (DE)

(72) Inventor: Florian KELLER, Gaimersheim (DE)

(73) Assignee: AUDI AG, Ingolstadt (DE)

(21) Appl. No.: 18/829,646

(22) Filed: Sep. 10, 2024

(30) Foreign Application Priority Data
Oct. 13, 2023 (DE) 102023128050.3

(51) Int. Cl. H01M 50/333; H01M 50/209; H01M 50/249

(52) U.S. Cl. CPC H01M 50/333; H01M 50/209; H01M 50/249; H01M 2220/20

(57) ABSTRACT

A battery cell arrangement which has a battery cell with a cell housing which has a first housing wall and a releasable cell degassing opening arranged therein, and a gas guiding device which has a base element arranged on the first housing wall, a releasable gas outlet opening in the base element and a flap which is arranged on the base element, and which closes the releasable gas outlet opening in a first position and covers the cell degassing opening, and which can be displaced into a second, opened position in which the gas outlet opening is released. The gas guiding device includes at least one first deformable connecting element which connects the flap to the base element in a first flap region of the flap which is different from an end region.

### FIELD

The invention relates to a battery cell arrangement with a gas guiding device, wherein the battery cell arrangement has a battery cell with a cell housing which has a first housing wall and a releasable cell degassing opening arranged in the first housing wall, wherein the gas guiding device has a base element which is arranged on the cell housing, a releasable gas outlet opening in the base element and a flap which is arranged on the base element and which, in a first flap position, closes the releasable gas outlet opening and covers the cell degassing opening, the flap being displaceable into a second opened position in which the gas outlet opening is released, the flap having a first end region which is detached from the base element in the second position and a second end region opposite the first end region, which second end region is arranged on a base element in the second position and comprises a first side edge in a second side edge opposite the first side edge, which side edges each extend from the first end region to the second end region. Furthermore, the invention also relates to a motor vehicle with such a battery cell arrangement.

### BACKGROUND

Galvanic elements, in particular secondary cells, which are also referred to as battery cells in the context of the invention, have the possibility of forming high temperatures and gas pressures within the housing as part of electrochemical processes, usually outside normal operating conditions. These are released into the environment when defined limits are exceeded, which is also referred to as an accident. In the case of multiple connections of galvanic elements in batteries, this can have a negative effect on the surrounding cells, as these can be damaged by high-temperature gases or even be stimulated to react themselves. For this purpose, an attempt is made to create a barrier that prevents hot escaping gas from reaching the surfaces of the still intact galvanic elements as far as possible.

DE 10 2014 208 062 A1 describes a battery system with multiple battery cells, each of which has a degassing opening, and a degassing device which has multiple inlet openings, wherein the battery cells are each connected to the degassing device via a connecting element which connects the degassing opening to an inlet opening of the degassing device. The connecting elements are designed in such a way that the gas pressure generated in the degassing device during degassing causes the degassing device to be moved towards the degassing battery cell. This is intended to achieve an increased sealing effect. The inlet opening of the degassing device can be designed with a closure element that opens the inlet opening under the influence of a fluid escaping from the degassing opening of a battery cell connected via a connecting element. The closure element can be a non-return valve or a burst element. The sealing openings can prevent the fluid from flowing out of the degassing device via the inlet openings connected to other battery cells.

Nevertheless, the aim remains to provide increased protection for battery cells that are still intact in the event of a thermal runaway.

### SUMMARY

The object of the present invention is to provide a battery cell arrangement and a motor vehicle which, in the event of gas leaking from a battery cell, make it possible to provide increased protection for other battery cells which are still intact.

A battery cell arrangement according to the invention with a gas guiding device has a battery cell with a cell housing which has a first housing wall and a releasable cell degassing opening arranged in the first housing wall. Furthermore, the gas guiding device comprises a base element which is arranged on the cell housing, in particular on the first housing wall, a releasable gas outlet opening in the base element, and a flap arranged on the base element which, in a first flap position, closes the releasable gas outlet opening and covers the cell degassing opening. The flap can be displaced into a second opened position, in which the gas outlet opening is released, the flap having a first end region, which is detached from the base element in the second position, and a second end region opposite the first end region, which is arranged on the base element in the second position. In addition, the flap comprises a first side edge and a second side edge opposite thereto, which each extend from the first end region to the second end region. The gas guiding device comprises at least one first deformable connecting element which connects the flap to the base element in a first flap region of the flap which is different from the second end region.

The provision of such a first deformable connecting element has the great advantage that the flap can be stabilized in its second position. A maximum opening angle of the flap, for example, can be defined by such a first connecting element, which is sometimes also simply referred to as a connecting element in the following. Uncontrolled opening or tearing of the flap into an arbitrary second position in the event of gas escaping from the released cell degassing opening can thus be advantageously prevented. This in turn makes it possible for the flap to additionally implement a gas guiding function and gas shielding function. The flap opened in the second position can thus be used advantageously to direct the escaping gas flow in a desired direction and, conversely, to prevent it from flowing excessively in an opposite direction. In addition, the provision of such a first deformable connecting element facilitates the connection of the flap to the base element, since such a connection then does not have to be implemented in a complex manner, e.g. by means of a hinge with a non-return function or the like. For example, the flap can be opened simply by bending it open as a result of the gas pressure. Opening the flap can cause the deformation of the deformable connecting element. As the flap in the second position ultimately provides a significantly more stable and precise gas control function and gas shielding function, an increased protective function can be provided in the event of a gas leak from the battery cell, e.g. for neighboring battery cells that are still intact. The flap can be used to direct the escaping gas flow so that it is not directed towards a neighboring cell if possible. In the first position of the flap, on the other hand, it can provide an additional protective function for the releasable cell degassing opening. If, for example, another battery cell discharges, the gas escaping from this cell cannot come into contact with the releasable cell degassing opening of the battery cell or can do so only with considerable difficulty, as this is also covered by the flap closing the gas outlet opening.

A battery cell is considered a galvanic element, in particular an electrochemical storage cell. The battery cell can, for example, be designed as a lithium-ion cell. Preferably, the battery cell is a prismatic battery cell that has an essentially cuboidal cell housing. However, applications for round cells and/or pouch cells are also conceivable. The releasable cell degassing opening is designed in such a way that it is normally closed and can be passively released depending on the pressure, in particular if an internal pressure in the cell housing exceeds a predetermined threshold value. The releasable cell degassing opening can, for example, be designed as a pressure relief valve and/or bursting diaphragm or similar. It can also be designed as a predetermined breaking point in the cell housing. If the releasable cell degassing opening is in the closed state, the battery cell, in particular the cell housing, is atmospherically sealed.

The base element of the gas guiding device is preferably designed to fix the gas guiding device to the battery cell. The gas guiding device as a whole can, for example, be provided in the form of an attachment which is placed on the first housing wall or fixed to the first housing wall or generally to the cell housing. The base element holds the flap on the battery cell, so to speak.

Furthermore, it is preferred that the gas guiding device is a gas guiding device associated only with the battery cell. In a battery with multiple battery cells, it is preferred that each of these battery cells comprises such a gas guiding device, which is arranged on the associated battery cell, in particular only on the associated battery cell.

The gas guiding device is preferably made of a material that is as temperature-resistant as possible and comprises, for example, a metallic material, e.g. steel or stainless steel, and/or a non-metallic material, e.g. glass fibers, mica or other materials. Fiber-reinforced plastics, e.g. plastics reinforced with glass fibers and/or ceramic fibers or the like, are also conceivable. The flap can have a geometry corresponding to the releasable gas outlet opening in the open state. The gas outlet opening can, for example, be round or square or have any desired geometry, wherein a rectangular geometry is preferred. The same applies to the flap. The fact that the flap closes the releasable gas outlet opening in the first position does not necessarily mean that it is closed by the flap in an atmosphere-tight and/or fluid-tight manner. Preferably, in the first position, the flap merely rests positively against the base element and covers or overlap the gas outlet opening. A sealing closure therefore does not have to be provided by the flap. When the flap is opened, i.e. during the transition from the first position to the second position, the second end region remains on the base element. The second end region of the flap therefore contacts the base element, i.e. both in the first position and in the second position of the flap, and preferably also in any intermediate position between the first and second position during the transition from the first position to the second position. In the first position of the flap, the first end region of the flap lies against or adjoins the base element or is at least positioned closer to the base element than in the second position of the flap. When the flap is opened, the first end region therefore moves away from the base element. At least in the second position of the flap, the first end region is no longer in direct contact with the base element. The flap itself can be designed as an essentially flat component.

Furthermore, it is preferred that the releasable gas outlet opening is directly opposite the releasable cell degassing opening with respect to a first direction. The releasable gas outlet opening is preferably at least as large as the releasable cell degassing opening or larger.

The flap is connected to the base element via the deformable connecting element at a point on the flap, namely the first flap region, which is different from the second end region of the flap and therefore does not represent the second end region or is located in the second end region. For example, the flap can be connected to the base element at its side edges or the first end region via the connecting element. The connecting element is therefore attached to the first flap region of the flap on the one hand and to the base element on the other. As a result, an improved stabilizing effect and holding effect of the flap in its second position can be achieved through the greater leverage due to the further distance from the axis of rotation, which is located in the region of the second end region.

Furthermore, the gas guiding device is designed such that the flap assumes the second position when the battery cell is in a degassing state in which gas escapes from the cell degassing opening. In particular, the transition of the flap from the first to the second position is caused by the gas pressure of the gas escaping from the cell degassing opening of the battery cell and/or by opening the releasable cell degassing opening. The flap therefore opens passively and requires no actuation to move it from the first position to the second position.

According to an advantageous embodiment of the invention, the flap can be moved from the first position to the second position by bending in the first end region. Thus, no hinge or other mechanism is required to enable the flap to be opened. The flap can be opened simply by bending the flap in the second end region. This enables a particularly simple and cost-effective design of the gas guiding device.

According to an advantageous embodiment of the invention, the first end region of the flap is connected to the base element in a material-locking manner. For example, the flap can even be formed in one piece with the base element or the flap can be welded or glued or otherwise attached to the base element.

According to a further advantageous embodiment of the invention, the gas guiding device is designed such that, in the second position, the flap has an inclined position relative to an opening plane in which the released gas outlet opening is located and the flap is located in an outlet path running through the gas outlet opening and perpendicular to the opening plane, in particular wherein the second position of the flap represents a maximum open position of the flap and the at least one first connecting element defines a maximum opening angle of the flap in the second position, which is in particular less than 90 degrees. By tilting the flap in the second position, a particularly advantageous deflecting effect of the flap can be achieved. In particular, with an inclined position at an angle of approx. 45 degrees, it is possible, for example, to deflect the gas flow exiting the battery cell along the outlet path by 90 degrees. Other opening angles and correspondingly different deflection angles are also conceivable, depending on the direction in which the gas flow is to be directed.

An opening angle of the flap that is smaller than 90 degrees can advantageously ensure that the flap in the second position is in the outlet path. The gas escaping from the battery cell thus hits the flap. Preferably, the maximum opening angle is less than 80 degrees, or even less than 70 degrees. This allows a particularly large effective region of the flap to be provided for gas deflection and shielding in the second position of the flap. Furthermore, it is preferred that the opening angle of the flap in the second position is at least 10 degrees, preferably at least 20 degrees, e.g. also more than 30 degrees. This can advantageously prevent a backflow effect of the escaping gas through the flap.

The at least one first connecting element can be designed to define this maximum opening angle. In other words, the connecting element ensures that the flap cannot be opened more than this maximum opening angle. The connecting element thus fulfills a retaining function. This can, for example, prevent the flap from assuming an opening angle of 90 degrees in the second position, in which a shielding effect may still be present, but no efficient gas guiding function or gas deflection function can be provided by the flap.

At least in the second position of the flap, the first end region of the flap can also comprise an edge of the flap which connects the first and second side edges to one another. If the flap is rectangular, these edges, namely the edge encompassed by the first end region and the two side edges, are perpendicular to each other, while the two side edges are parallel to each other. Since the second end region of the flap is attached directly to the base element, the second end region does not necessarily also have to provide an edge of the flap. Rather, the second end region comprises a boundary line of the flap that connects the first and second side edges. This can also be an imaginary boundary line. In the case of a rectangular flap, this boundary line can be parallel to the edge that is enclosed by the first end region of the flap. It is further preferred that the gas guiding device is arranged on the battery cell in such a way that this imaginary boundary line and/or the edge of the flap encompassed by the first end region extend in a longitudinal direction in the first position, which is parallel to a second direction. This second direction can be perpendicular to the first direction defined above. In addition, this second direction corresponds preferably to a stacking direction of a cell stack with multiple battery cells arranged next to one another, in particular prismatic battery cells, one of which represents the battery cell of the battery cell arrangement. Moreover, each battery cell of such a cell stack can be designed with a corresponding gas guiding device. Such a cell stack, which is also to be regarded as belonging to the invention, can thus comprise multiple battery cell arrangements arranged next to one another in the stacking direction. Due to the fact that the described boundary line is aligned parallel to the stacking direction, the flap folds open in a direction away from the neighboring cells of the cell stack during the transition to the second position. This allows the gas flow exiting the battery cell to be directed away from the neighboring cells and shielded from them.

According to a further advantageous embodiment of the invention, the gas guiding device has at least one second deformable connecting element which connects the flap to the base element in a second flap region of the flap which is different from the second end region and from the first flap region, in particular wherein the first flap region comprises the first side edge and the second flap region comprises the second side edge. In particular, the first connecting element and the second connecting element can be arranged or fastened at respective ends of the first and second side edges opposite the second end region. A further connecting element therefore advantageously makes it possible to hold the flap even more stably in its second position. In particular, the two connecting elements can be arranged symmetrically to one another or a connecting element can be arranged on a respective side edge of the flap. In principle, it would also be possible to arrange such a connecting element at the first end region of the flap, although this would have the disadvantage that the connecting element would be in the way of the outflowing gas flow in the second position of the flap. Therefore, positioning the connecting elements in the region of the side edges of the flap is very advantageous. Furthermore, the connecting elements can provide an additional lateral shielding effect when positioned in the region of the two side edges of the flap. Particularly with regard to the preferred positioning of the battery cell in a cell stack as described above, the protective function for the neighboring battery cells can thus be further increased. Furthermore, the second connecting element can be designed in the same way as described for the first connecting element. The following embodiments and descriptions, which refer to the first connecting element or to a connecting element in general, can also apply to the first connecting element and, by analogy, to the second connecting element. The first connecting element is therefore preferably attached on the one hand to the first side edge of the flap and on the other hand to the base element, and the second connecting element is preferably attached on the second side edge of the flap and on the other hand also to the base element. As a result, a significantly more reliable holding function can be provided for the flap, especially when it is in the second position.

According to a further advantageous embodiment of the invention, the at least one first connecting element, and in particular also the second connecting element, is a spring element which is designed to exert a restoring force on the flap in the second position in order to return the flap to the first position. Such a spring element can also be used to keep the flap stable in its first position, provided that no gas escapes from the battery cell. The gas escaping from the battery cell in the event of degassing causes the flap to open against the restoring force exerted on the flap by the spring element. The restoring force can also ensure that the flap does not open beyond its defined second position. In other words, the maximum opening angle of the flap can be limited by the restoring force. If the gas flow escaping from the battery cell in the event of degassing comes to a standstill, the restoring force can cause the flap to return to the first position or at least in the direction of the first position. The spring element can, for example, be designed as a spring, e.g. in the form of a leaf spring or spiral spring or similar. The connecting element can also comprise multiple such spring elements.

According to a further advantageous embodiment of the invention, the at least one first connecting element in the second position of the flap provides a shielding wall which partially or largely or completely covers an imaginary side surface which is spanned between the first side edge of the flap and a corresponding boundary edge of the base element delimiting the released gas outlet opening.

If the flap is therefore in the second position, an imaginary side surface is stretched between the first side edge of the flap and the corresponding boundary edge of the base element, which can be partially, in particular largely, or even completely covered by the shielding wall provided by the connecting element. This can advantageously provide a very reliable lateral shielding function. It is particularly advantageous if the above-mentioned second connecting element also provides a second shielding wall in a similar manner in the second position of the flap, which partially or largely or completely covers an imaginary second side surface, which is spanned between the second side edge of the flap and a corresponding second boundary edge of the base element delimiting the released gas outlet opening, wherein this second boundary edge can be positioned opposite the first boundary edge. If, for example, the gas outlet opening is a rectangular gas outlet opening, the boundary edges can be two parallel and opposite edges of this gas outlet opening. A length of the first side edge of the flap can essentially correspond to a length of this first boundary edge and/or the length of the second side edge of the flap can correspond to a length of the second boundary edge. In the first position of the flap, the first side edge can, for example, lie opposite the boundary edge, in particular the first boundary edge, and optionally directly adjoin it and/or rest against it. The same applies to the second side edge and the second boundary edge.

The shielding wall can be flexible. In other words, it should not be a rigid wall. The shielding wall can be provided by a thin-walled element, e.g. a thin-walled sheet metal or a sheet metal strip or another material strip or a film or similar.

In a further advantageous embodiment of the invention, the at least one connecting element represents the shielding wall, which is designed as a foldable shielding wall that has a folded state in the first position of the flap and has a second state that is unfolded with respect to the first state in the second position. In the second position, the foldable shielding wall does not have to be completely unfolded, i.e. it does not have to be completely flat, although this is still possible. As a result, the shielding wall takes up very little installation space, especially when the flap is in the first position, as it is folded in this position to save installation space. When the flap is opened, i.e. during the transition to the second position, the movement of the flap causes the shielding wall to unfold automatically and assume its lateral shielding function. The same can apply to the second opposite connecting element. This advantageously provides a lateral shielding function on both sides.

The configuration of the connecting element as a shielding wall can be combined with the configuration as a spring element. In other words, the connecting element, namely the first connecting element and/or the second connecting element, can comprise both a spring element and a shielding wall, which is designed like the shielding wall described. The shielding wall as such is designed in such a way that no restoring force can be provided by it. If such a force is required, a spring element can therefore also be provided as part of the connecting element. It may also be provided that the first connecting element is designed as a shielding wall or comprises such a wall, and the second connecting element is designed as a spring element or comprises such a spring element.

In a further advantageous embodiment of the invention, the flap is fixed in the first position by means of a fixing, wherein the fixing can be released by opening the releasable cell degassing opening and/or by a gas pressure acting on the flap from the direction of the cell degassing opening. The flap can be reliably held in the first position by fixing it in this way. This provides a particularly good protective function for the intact cell degassing openings. The fact that the fixing can be released in the event of gas escaping from the cell means that the flap can be reliably opened. The fixing can be provided by means of an adhesive, for example. For example, the flap can be glued to the base element in certain regions. The fixing can therefore be provided by a material-locking connection of the flap to the base element. The adhesive seam provided by the adhesive can tear open when gas escapes, allowing the flap to open.

According to a further advantageous embodiment of the invention, the gas guiding device is only arranged on the battery cell, in particular glued and/or clipped to the battery cell. It is preferred that the base element of the gas guiding device is glued and/or clipped to the cell housing of the battery cell. Providing a separate gas guiding device for each battery cell has the great advantage that this simplifies the arrangement of the gas guiding device on such a battery cell, as no tolerance compensation has to be provided with regard to different heights of the battery cells in relation to each other and/or for different distances between battery cells. Each battery cell can be provided with its own gas guiding device. No adjustment to geometries or distances to other battery cells needs to be advantageously taken into account.

The gas guiding device can optionally provide a type of housing when the flap is closed. The gas guiding device can then enclose an internal volume with a part of the first housing wall, for example. However, the base element can also rest directly against the first housing wall and/or be designed only as a frame around the gas outlet opening in order to enable the gas guiding device to be attached to the battery cell.

Furthermore, the invention also relates to a motor vehicle with a battery cell arrangement according to the invention or one of its embodiments.

Furthermore, the invention also relates to a battery, in particular a high-voltage battery, with a battery cell arrangement according to the invention or one of its embodiments. The battery may have a cell stack comprising multiple battery cell arrangements. The battery cells of the respective battery cell arrangements can be arranged next to each other in a stacking direction. The battery can also comprise multiple such cell stacks.

The invention also includes developments of the motor vehicle according to the invention and the battery according to the invention, which have features as already described in connection with the further embodiments of the battery cell arrangement according to the invention. For this reason, the corresponding developments of the motor vehicle according to the invention and the battery according to the invention are not described again here.

The motor vehicle according to the invention is preferably designed as a motor car, in particular as a passenger car or truck, or as a passenger bus or motorcycle.

The invention also includes combinations of the features of the embodiments described. The invention thus also includes implementations which each have a combination of the features of multiple of the embodiments described, provided that the embodiments have not been described as mutually exclusive.

### BRIEF DESCRIPTION OF THE FIGURES

Examples of embodiments of the invention are described below. In particular:

FIG. 1 shows a schematic perspective view of a battery with multiple battery cell arrangements according to an embodiment of the invention; and

FIG. 2 shows a schematic representation of a battery with multiple battery cell arrangements according to a further embodiment of the invention.

### DETAILED DESCRIPTION

The embodiments described below are preferred embodiments of the invention. In the exemplary embodiments, the described components of the embodiments each represent individual features of the invention which are to be considered independently of each other and which also further form the invention independently of each other. Therefore, the disclosure is also intended to include combinations of the features of the embodiments other than those shown. Furthermore, the described embodiments can also be supplemented by further features of the invention already described.

In the figures, same reference numerals denote elements with the same function.

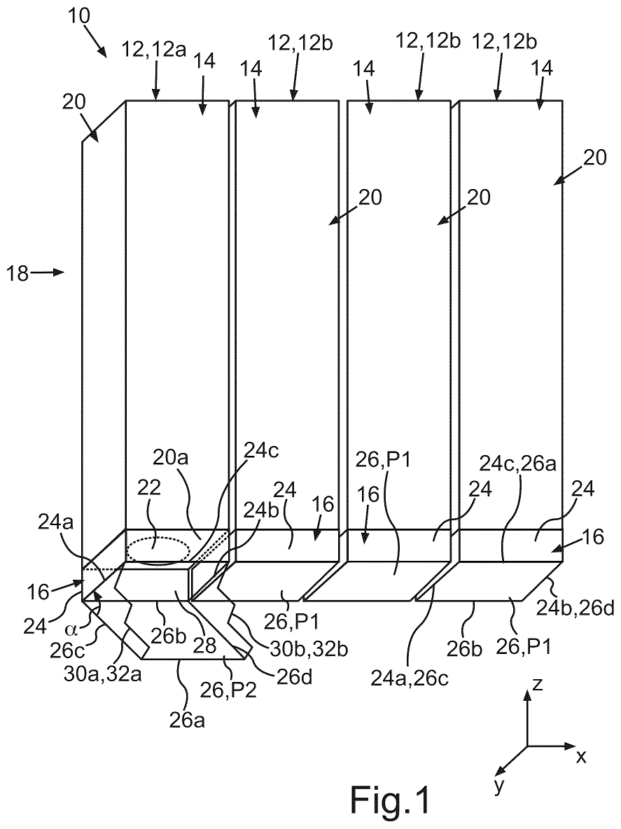

FIG. 1 shows a schematic representation of a battery 10 with multiple battery cell arrangements 12 according to an embodiment of the invention. Each battery cell arrangement 12 comprises a battery cell 14, which in the present case is formed as a prismatic battery cell, and a gas guiding device 16, which is arranged on the associated battery cell 14. The battery 10 can comprise a cell stack 18, which in turn comprises the battery cells 14. The battery cells 14 can be arranged next to one another in a stacking direction, with this stacking direction corresponding to the x-direction shown.

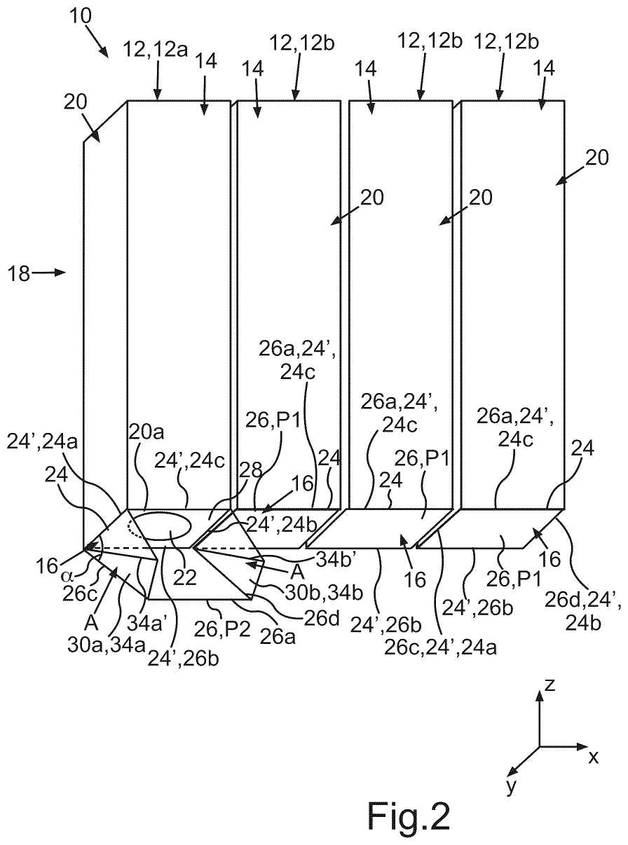

In addition, FIG. 1 and FIG. 2 each show a coordinate system which is a Cartesian coordinate system. The aforementioned first direction can correspond to the z-direction shown and the aforementioned second direction to the x-direction shown. The y-direction is defined perpendicular to the x- and z-direction shown.

The battery cell arrangements 12 can be of the same or similar design, so that the following descriptions, which relate to such a battery cell arrangement 12, can apply analogously to the other battery cell arrangements 12.

The battery cell 14 has a cell housing 20, which comprises a first housing side 20a. A releasable cell degassing opening 22 is arranged in the first housing side 20a. This is closed in the normal state and can be released depending on the pressure in order to allow outgassing of the battery cell 14. The gas guiding device 16 comprises a base element 24, which is attached to the battery cell 14, in particular to its cell housing 20. In the present case, the base element 24 is arranged on the first housing wall 20a. The base element 24 can be glued or clipped to the cell housing 20, for example. In addition, the gas guiding device 16 comprises a flap 26, which can assume at least a first position P1 and a second position P2. For one of the battery cell arrangements 12, also referred to herein as 12a, the flap 26 is shown in the second position P2, while the flap 26 of the remaining battery cell arrangements 12, also referred to herein as 12b, is in the first position P1. The flap 26 generally includes a first end region 26a and a second end region 26b opposite the first end region 26a. In addition, the flap 26 comprises a first side edge 26c and a second side edge 26d opposite the first side edge 26c. The two side edges 26c, 26d each connect the first end region 26a with the second end region 26b of the flap 26.

A releasable gas outlet opening 28 is arranged in the base element 24. If the flap 26 is in the first position P1, the flap 26 closes the releasable gas outlet opening 28 and at the same time covers the releasable cell degassing opening 22. In the second position P2 of the flap 26, the gas outlet opening 28 is released. A gas escaping through the cell degassing opening 22 can thus escape via the gas outlet opening 28. In particular, such a gas escaping from the cell degassing opening 22 causes the flap 26 to open automatically and passively due to the pressure exerted by the gas on the flap 26. The second end region 26b of the flap 26 remains on the base element 24, i.e. is arranged on the base element 24 both in the first position P1 and in the second position P2 as well as in an arbitrary intermediate position which the flap 26 assumes during the transition from the first position P1 to the second position P2.

Advantageously, the gas guiding device 16 has at least one deformable connecting element 30a, 30b, which in this example is designed as a spring element 32a, 32b. In particular, the gas guiding device 16 in this example comprises two such connecting elements, namely a first connecting element 30a and a second connecting element 30b, which are each designed as spring elements 32a, 32b. The first spring element 32a is arranged at the first side edge 26c, in particular in the present example at a corner at which the first side edge 26c and the first end region 26a meet, and the second spring element 32b is arranged at the second side edge 26d, in particular at a corner at which the second side edge 26d meets the first end region 26a. Both spring elements 32a, 32b are also arranged on the base element 24. The first spring element 32a is arranged with an opposite end at a first boundary edge 24a of the base element 24, which delimits the releasable outlet opening 28, and the second spring element 32b is arranged at a second boundary edge 24b of the base element 24, which delimits the gas outlet opening 28 on the opposite side. In particular, the spring elements 32a, 32b are in turn arranged at the corresponding corners at which the respective boundary edges 24a, 24b adjoin a further boundary edge 24c of the base element 24. The spring elements 32a, 32b are thus arranged with their respective ends facing the base element 24 at the ends of the two boundary edges 24a, 24b facing away from the second end region 26b. As a result, the holding effect of the flap 26 in the second position P2 provided by the connecting element 30a, 30b can be optimized. The connecting elements 30a, 30b can define an opening angle α for the flap 26, which is the maximum angle of the flap in the second position P2. In the present example, the flap 26 has an inclined position in the second position P2 relative to a plane in which the released gas outlet opening 28 is located, wherein this plane is parallel to the x-y plane shown. Due to this inclined position, it is advantageously possible to deflect the gas flow exiting the cell 14 by means of the flap 26 on the one hand and to shield it in the opposite direction on the other. In this example, the flap 26 can be used to deflect the outgoing gas flow in the opposite y-direction, for example. This can prevent a large proportion of the outflowing gas from flowing in or against the x-direction to the neighboring cells 14. These are also additionally protected by the still closed flaps 26. If the outflowing gas flow decreases, the spring elements 32a, 32b can be used to return the flap 26 in the direction of its first position P1 or even to its first position P1.

This means that the defined degassing region of the element, i.e. the battery cell arrangement 12, is equipped with a flexible element, namely the flap 26, which allows free opening during the accident and at the same time prevents the gas from flowing in the opposite direction.

With a barrier that only acts in one direction, which is provided by the gas guiding device 16, in particular by the open flap 26, the flow resistance during an outgassing process is minimized. At the same time, flow in opposite directions and thus the thermal load can be kept away from the galvanic element, in particular of neighboring cells 14. The design also makes it possible to adjust the outflow resistance and the protection in the opposite direction. In addition, it is possible to direct the gas flow and thus minimize the effects of the accident on the battery 10.

In this example, the secondary cell, which is referred to here as battery cell 14, is equipped with an opening element, namely the releasable cell degassing opening 22, which opens in a pressure- and/or temperature-sensitive manner and thus allows degassing in the event of an accident. Covering this is a protective element in the form of the flap 26, which is opened in a pressure-controlled manner via a preloaded spring element 32a, 32b and releases the gas into the surrounding battery compartment. The protective element, i.e. the flap 26, is preferably made of a thermally highly resistant material and thus enables the neighboring secondary cells 14 to be protected from the hot gases of the failing secondary cell 14 in the event of an accident. This structure also allows the escaping gas to be guided.

FIG. 2 shows a schematic representation of a battery 10 according to a further embodiment of the invention. This can be designed as described for FIG. 1, except for the differences described below. These essentially refer to the design of the gas guiding device 16. In this example, it also comprises a flap 26, which can assume a first position P1 and a second position P2, which are defined as described for FIG. 1. In the present case, the base element 24 of the gas guiding device 16 can be provided by a part of the first housing wall 20a of the cell housing 20 itself, i.e. the flap 26 can, for example, be arranged directly on the first housing wall 20a or the base element 24 can be provided in the form of a plate arranged directly on the first housing wall 20a with an opening in the region of the releasable cell degassing opening 22 or can be provided merely in the form of a frame which extends along the contour lines designated 24′.

In this example, the two connecting elements 30a, 30b are provided in the form of two foldable shielding walls 34a, 34b. On the one hand, these are in turn attached to the respective side edges 26c, 26d and, on the other hand, to the two boundary edges 24a, 24b, which delimit the releasable gas outlet opening 28. Between the first side edge 26c and the first boundary edge 24a, a first imaginary surface A is spanned, which is covered by the first foldable shielding wall 34a in the second position P2 of the flap, and between the second side edge 26d and the second boundary edge 24b, a further imaginary surface A is spanned, which is covered by the second foldable shielding wall 34b when the flap 26 is in the second position P2. In the first position P1 of the flap 26, this respective foldable shielding wall 34a, 34b is folded together, as shown for the battery cell arrangements 12b. The folded edges of the respective shielding walls 34a, 34b are labeled 34a′ and 34b′ in the present case. More than one individual folding edge 34a′, 34b′ can also be provided per foldable shielding wall 34a, 34b.

In this example, the secondary cell, i.e. the battery cell 14, is again equipped with an opening element, which is provided by the releasable cell degassing opening 22, and which opens in a pressure- and/or temperature-sensitive manner and thus allows degassing in the event of an accident. Covering this is another protective element, namely the gas guiding device 16 with the flap 26, which has a folded structure in the closed state P1. When pressurized, this protective element, in particular the shielding walls 34a, 34b surrounded by it, is unfolded and releases the gas flow during the accident. The protective element, i.e. the gas guiding device 16, is preferably made of a thermally highly resistant material and thus enables the neighboring secondary cells 14 to be protected from the hot gases of the damaged secondary cell 14 in the event of an accident. The structure also allows the escaping gas to be guided.

In this example too the shielding walls 34a, 34b can define a maximum opening angle α for the flap 26 in the second position P2. The flap 26 can thus be held stably in its second position P2.

Overall, the examples show how the invention can provide a one-sided insulating degassing barrier for galvanic elements.

1. A battery cell arrangement with a gas guiding device, wherein the battery cell arrangement comprises a battery cell with a cell housing having a first housing wall and a releasable cell degassing opening arranged in the first housing wall,
wherein the gas guiding device has a base element which is arranged on the cell housing,
has a releasable gas outlet opening in the base element, and
comprises a flap arranged on the base element, which in a first position closes the releasable gas outlet opening and covers the cell degassing opening,
wherein the flap can be displaced into an opened second position, in which the gas outlet opening is released,
wherein the flap has a first end region, which is detached from the base element in the second position, and a second end region opposite the first end region, which is arranged on the base element in the second position, and comprises a first side edge and a second side edge opposite thereto, which each extend from the first end region to the second end region,
wherein the gas guiding device has at least one first deformable connecting element which connects the flap to the base element in a first flap region of the flap which is different from the second end region.

2. The battery cell arrangement according to claim 1, wherein the flap can be moved from the first position to the second position by bending in the second end region, in particular wherein the second end region of the flap is connected to the base element in a material-locking manner.

3. The battery cell arrangement according to claim 1, wherein the gas guiding device is designed such that the flap in the second position has an inclined position relative to an opening plane in which the released gas outlet opening is located and the flap is located in an outlet path extending through the gas outlet opening and perpendicular to the opening plane, in particular wherein the second position of the flap represents a maximum open position of the flap and the at least one first connecting element defines a maximum opening angle of the flap in the second position, which is in particular smaller than 90°.

4. The battery cell arrangement according to claim 1, wherein the gas guiding device has at least one second deformable connecting element which connects the flap to the base element in a second flap region of the flap which is different from the second end region and from the first flap region, in particular wherein the first flap region comprises the first side edge and the second flap region comprises the second side edge.

5. The battery cell arrangement according to claim 1, wherein the at least one first connecting element is a spring element which is designed to exert a restoring force on the flap in the second position in order to return the flap to the first position.

6. The battery cell arrangement according to claim 1, wherein the at least one first connecting element in the second position of the flap provides a shielding wall which partially or largely or completely covers an imaginary side surface which is spanned between the first side edge of the flap and a corresponding boundary edge of the base element delimiting the released gas outlet opening.

7. The battery cell arrangement according to claim 1, wherein the at least one first connecting element represents the shielding wall, which is designed as a foldable shielding wall, which in the first position of the flap has a folded state, and in the second position has a second state which is unfolded with respect to the first state.

8. The battery cell arrangement according to claim 1, wherein the flap is fixed in the first position by means of a fixing, wherein the fixing can be released by opening the releasable cell degassing opening and/or by a gas pressure acting on the flap from the direction of the cell degassing opening.

9. The battery cell arrangement according to claim 1, wherein the gas guiding device is only arranged on the battery cell, in particular is glued and/or clipped to the battery cell.

10. A motor vehicle with a battery cell arrangement according to claim 1.

11. The battery cell arrangement according to claim 2, wherein the gas guiding device is designed such that the flap in the second position has an inclined position relative to an opening plane in which the released gas outlet opening is located and the flap (26) is located in an outlet path extending through the gas outlet opening and perpendicular to the opening plane, in particular wherein the second position of the flap represents a maximum open position of the flap and the at least one first connecting element defines a maximum opening angle of the flap in the second position, which is in particular smaller than 90°.

12. The battery cell arrangement according to claim 2, wherein the gas guiding device has at least one second deformable connecting element which connects the flap to the base element in a second flap region of the flap which is different from the second end region and from the first flap region, in particular wherein the first flap region comprises the first side edge and the second flap region comprises the second side edge.

13. The battery cell arrangement according to claim 3, wherein the gas guiding device has at least one second deformable connecting element which connects the flap to the base element in a second flap region of the flap which is different from the second end region and from the first flap region, in particular wherein the first flap region comprises the first side edge and the second flap region comprises the second side edge.

14. The battery cell arrangement according to claim 2, wherein the at least one first connecting element is a spring element which is designed to exert a restoring force on the flap in the second position in order to return the flap to the first position.

15. The battery cell arrangement according to claim 3, wherein the at least one first connecting element is a spring element which is designed to exert a restoring force on the flap in the second position in order to return the flap to the first position.

16. The battery cell arrangement according to claim 4, wherein the at least one first connecting element is a spring element which is designed to exert a restoring force on the flap in the second position in order to return the flap to the first position.

17. The battery cell arrangement according to claim 2, wherein the at least one first connecting element in the second position of the flap provides a shielding wall which partially or largely or completely covers an imaginary side surface which is spanned between the first side edge of the flap and a corresponding boundary edge of the base element delimiting the released gas outlet opening.

18. The battery cell arrangement according to claim 3, wherein the at least one first connecting element in the second position of the flap provides a shielding wall which partially or largely or completely covers an imaginary side surface which is spanned between the first side edge of the flap and a corresponding boundary edge of the base element delimiting the released gas outlet opening.

19. The battery cell arrangement according to claim 4, wherein the at least one first connecting element in the second position of the flap provides a shielding wall which partially or largely or completely covers an imaginary side surface which is spanned between the first side edge of the flap and a corresponding boundary edge of the base element delimiting the released gas outlet opening.

20. The battery cell arrangement according to claim 5, wherein the at least one first connecting element in the second position of the flap provides a shielding wall which partially or largely or completely covers an imaginary side surface which is spanned between the first side edge of the flap and a corresponding boundary edge of the base element delimiting the released gas outlet opening.
